(19) United States
(12) Patent Application Publication
(10) Pub. No.: US 2009/0125148 A1
(43) Pub. Date: May 14, 2009

(54) Control Unit for an Awning

(76) Inventors: Hermanus Marinus Ignatius Koot, Montfoort (NL); Robertus Andreas Schuckman, Utrecht (NL)

Correspondence Address: GORDON & REES LLP, 101 WEST BROADWAY, SUITE 1600, SAN DIEGO, CA, 92101, US

(21) Appl. No.: 12/084,870

(22) PCT Filed: Nov. 14, 2006
(86) PCT No.: PCT/NL2006/000567

§ 371 Date: Jul. 21, 2008

(30) Foreign Application Priority Data
Nov. 14, 2005 (NL) 1030410

(51) Int. Cl. G05B 15/02

(52) U.S. Cl. 700/275

(57) ABSTRACT

The present invention relates to a control unit for controlling the motor drive for a sunblind, comprising:—an electric drive motor with which the sunblind can be driven;—an electric power supply; and—a universal, programmable microcontroller connected to the power supply and provided with:—at least one input port for receiving first operating signals according to a first signal protocol and/or for receiving second operating signals according to a second protocol differing from the first protocol, and—a control port coupled to the drive motor for transmitting to the drive motor a control signal with which the drive motor can be switched on and off; wherein the microcontroller is adapted to receive an incoming operating signal, to determine the protocol followed by the operating signal, to convert the operating signal into the correct control signal for the drive motor, and to transmit the control signal to the drive motor.

The present invention relates to a control unit for controlling the motor drive for a sunblind. The invention also relates to a sunblind provided with such a control unit, and to the use of the control unit.

Numerous types of inside and outside sunblinds are commercially available, including curtains on a curtain rail, optionally raisable roller blinds, pleated and cellular shades, folding blinds, vertical slat blinds, horizontal slat blinds (also referred to as Venetian blinds). In the case of for instance Venetian blinds the horizontal slats can be tilted in order to regulate the amount of sunlight entering a space. In some types of sunblind the slats can not only be tilted but can also be raised or lowered. In many cases the tilting and/or raising and lowering of the slats takes place with an electric drive motor powered via the domestic mains supply or via a battery. The drive motor to be applied depends on, among other factors, the type and the dimensions of the sunblind. As a result of the fact that there are numerous different types of sunblind, in practice numerous types of drive motor are also applied. For controlling of such motors it is known to apply electronic controls such as microcontrollers, the hardware of which has been made suitable for the specific type of drive motor. For a manufacturer of sunblinds this entails rather complex logistics. A great number of different types of control units must be held in stock.

The above stated control of the drive motor is operated by a user using an operating unit coupled to the control unit wirelessly or via a wire, such as an infrared remote control, an on/off-switch or a radio frequency remote control. The hardware of the known controls must again be made suitable for the type of operating unit to be applied. An infrared remote control for instance provides operating signals which require a different processing than for instance operating signals from a radio frequency remote control, since the different signals follow different signal protocols. An infrared signal thus usually complies with the IrDA standard (“Infrared Data Association” standard) for wireless communication, while radio frequency signals in this field comply for instance with the Directive 199/5/EC relating to “Radio Equipment and Telecommunications Terminal Equipment and the mutual recognition of their conformity”. A control unit adapted specifically for the relevant protocol must therefore be provided in the sunblind for all possible protocols for the operating signals. This requires rather complex logistics. This also makes the control units relatively expensive, since a relatively large number of different control units must be held in stock. A further drawback of applying different control units is that the installation thereof by the manufacturer and/or an installer and the operation for the customer are rather complex and always different, whereby there is a relatively great chance of mistakes during installation and servicing period.

Microcontrollers are also known which can be made suitable for processing different protocols for operating signals by placing one or more additional conversion circuits in front of the microcontroller. When for instance a microcontroller suitable for processing infrared signals must be modified for the purpose of processing radio frequency signals, in this type of known microcontroller a hardware component is added to the microcontroller. This involves a further complication and thereby an increase in cost of the control unit.

A control system for the drive motor of a sunblind is known from the U.S. Pat. No. 6,069,465. The system is assembled from a control unit provided with a microprocessor, wherein the control unit is connected to a motor drive. The system has a first input for receiving motor control signals via a data and transmission line. Data signals can be transmitted to the input of the microprocessor using a switch. The control unit can herein function in two different modes, a master mode and a slave mode. Placing of the control unit in the master or slave mode takes place by manual operation of one or more dip-switches. When the control unit receives an operating signal, a check is first made as to whether the signal includes the address of the control unit in question. If the signal does indeed comprise the address, the control unit is activated while in the opposite case the signal is ignored by the control unit.

Although in the known system whether or not the control unit is activated is determined subject to the address co-transmitted in the control signal, in the known system the control unit is also only suitable for a single, predetermined protocol of the control signal. A change in the protocol followed by the control signal necessitates adjustment of the hardware and/or software of the system. For the above stated reasons this results in complex logistics and relatively high installation costs.

It is an object of the present invention to provide a control unit for a sunblind in which at least the above stated drawbacks are obviated.

It is also an object of the present invention to provide a more universally applicable control unit.

According to a first aspect of the present invention, there is provided for this purpose a control unit for controlling the motor drive for a sunblind, comprising:
an electric drive motor with which the sunblind can be driven;
an electric power supply; and
a universal, programmable microcontroller connected to the power supply and provided with:
   at least one input port for receiving first operating signals according to a first signal protocol and/or for receiving second operating signals according to a second protocol differing from the first protocol, and
   a control port coupled to the drive motor for transmitting to the drive motor a control signal with which the drive motor can be switched on and off, wherein the microcontroller is adapted to receive an incoming operating signal, to determine the protocol followed by the operating signal, to convert the operating signal into the correct control signal for the drive motor subject to the determined protocol, and to transmit the control signal to the drive motor.

Because the microcontroller is adapted to determine the specific protocol followed by the received operating signal and to interpret the operating signal subject to the determined protocol such that a correct control signal for the drive motor is generated, the control unit is made suitable for processing many different types of operating signal without intervention by the user (such as for instance the manufacturer or the installer) being necessary. This results in simplifying of the manufacture of the sunblind, and moreover provides a considerable logistic advantage. The control unit hereby also becomes more versatile, since it is automatically suitable for processing signals from two or more different input protocols.

According to a first embodiment, the microcontroller comprises a first input and/or output port for receiving and/or transmitting first operating signals according to a first signal protocol, and a second input and/or output port for receiving and/or transmitting second operating signals according to a second protocol. In this embodiment the microcontroller comprises two or more ports at which operating signals following different protocols can be inputted. The microcontroller is able to process operating signals from each of the ports into the correct control signal for the relevant drive motor.

According to a further preferred embodiment, the microcontroller is programmed by a program stored in the microcontroller and comprising information about two or more different protocols, on the basis of which information the microcontroller determines which of the protocols is being followed by the operating signal. By loading the correct programme into the microcontroller it can be made suitable for processing different input protocols. When a protocol changes or another protocol becomes relevant, the functionality of the microcontroller can be readily adapted by loading a modified programme. The microcontroller can therefore be of the universal type and be made suitable in simple manner for processing an operating signal with differing protocols through a correct programming thereof, without hardware modifications here being necessary.

According to a further preferred embodiment, the microcontroller is adapted to determine the type of drive motor.

According to a further embodiment, the microcontroller is adapted to generate the control signal subject to the type of drive motor. The microcontroller first of all detects which type of drive motor is being applied and, depending on information stored in the microcontroller, the control signal suitable for the relevant type of drive motor can be generated.

According to a determined preferred embodiment, the control unit comprises a receiver connected to a port for receiving signals from a remote control and converting the received signals into the first and/or second operating signals. The receiver can herein be an infrared receiver for wirelessly receiving infrared signals and for converting thereof into an electrical operating signal.

In another embodiment the receiver can be a radio frequency receiver for wireless reception of radio frequency signals and conversion thereof into an electrical operating signal.

In another preferred embodiment the receiver can be an electrical on/off-switch connected to a port for providing an operating signal for the microcontroller.

In yet another preferred embodiment the operating unit comprises a communication line connected to a port for providing an operating signal for the microcontroller. The communication line can for instance be a serial RS485 communication cable which can provide contact with a computer.

According to another embodiment, the microcontroller is adapted to convert an operating signal into a control signal for adjusting the direction of rotation of the drive motor. The direction of rotation (such as counter-clockwise and clockwise) determines for instance whether a sunblind is opened or conversely closed, or whether slats are displaced up or downward.

According to another preferred embodiment, the microcontroller is adapted to convert an operating signal into a control signal for adjusting the rotation speed of the drive motor. The rotation speed can for instance determine the speed at which a horizontal slat is displaced up or downward.

According to another aspect of the invention, there is provided a sunblind comprising a frame provided with a sunblind material, wherein a control unit as according to any of the foregoing claims is provided in the frame and wherein the drive motor is embodied for the purpose of displacing the sunblind material in order to adjust the degree of sun protection.

In a specific embodiment the frame comprises an upper frame in which the control unit is arranged and to which a number of slats are attached, wherein the drive motor is embodied for tilting the slats and/or for raising or lowering the slats. The control signals generated by the control unit ensure that the slats can be tilted and/or raised or lowered as desired.

Further advantages, features and details of the present invention will be elucidated on the basis of the following description of a preferred embodiment thereof. Reference is made in the description to the figures, in which:

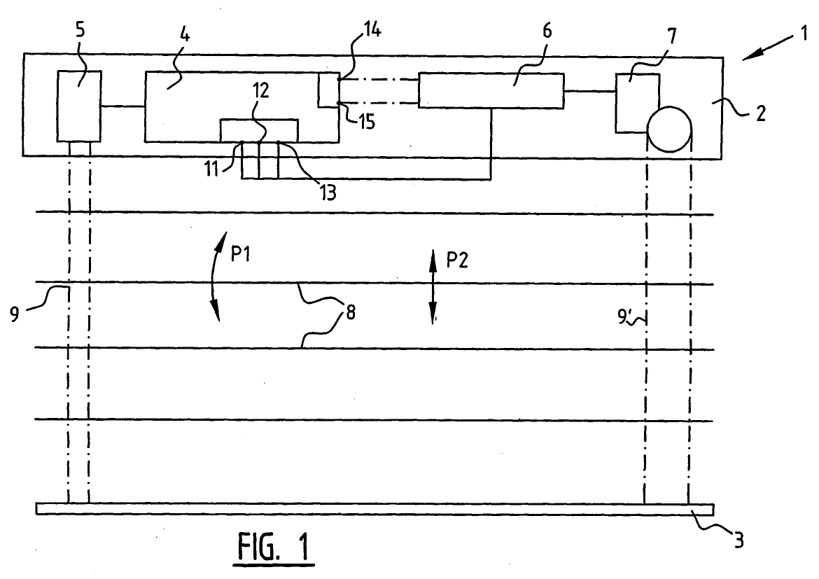

FIG. 1 shows a schematic view of a sunblind with horizontal slats, in which a control unit according to a preferred embodiment of the invention is applied; and

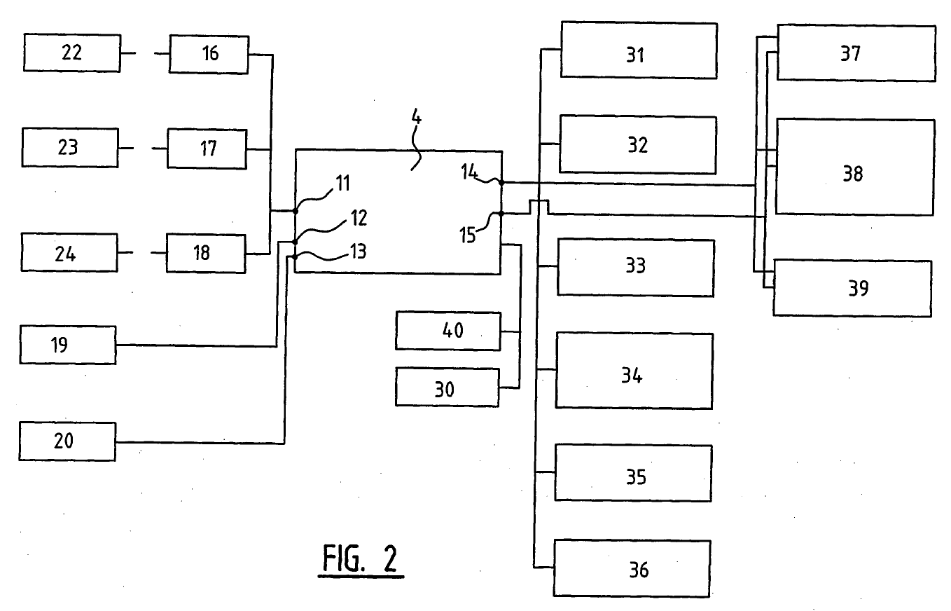

FIG. 2 shows a schematic view of the drive motors and remote controls co-acting with the control unit of FIG. 1.

FIG. 1 shows a sunblind 1 which is constructed from an upper frame or upper rail 2 to which a number of horizontal slats 8 are attached. A displaceable frame part 3 is also provided on the underside of the sunblind. Such sunblinds are available in many embodiments and variants known to the skilled person. In a manner known to the skilled person the slats 8 and displaceable frame part 3 are attached to upper rail 2 via drive cords 9,9′. Arranged in upper rail 2 is a drive motor 6 which can operate cords 9,9′ via a transmission 7. The cords can for instance tilt the slats (P₁) or raise or lower the slats (P₂). Such sunblinds are generally known to the skilled person and a further description thereof can therefore be dispensed with.

In addition to drive motor 6, there are also provided in upper rail 2 a power supply, for instance a battery or accumulator power supply 40 or a transformer 30 connected to the domestic mains supply, and a control unit 4. Control unit 4 comprises a microcontroller 10 in addition to a number of input ports 11,12,13 and a number of motor control ports 14 and 15. An infrared receiver 16, a basic radio frequency receiver 17 or a more comprehensive radio frequency receiver 18 can be connected as desired to one of the input ports 11-13. A standard electrical on/off switch 19 can be connected to another input port 11-13, while a serial communication line 20 can be connected to a further input port 11-13, as shown schematically in FIG. 2. To motor control port 14 can also be connected a drive motor, for instance of a type in which no position detection takes place. Examples of such drive motors are horizontal slat blinds 31 of the exclusively tilting type, vertical slat blinds 32 of the exclusively tilting type, reciprocally slidable vertical slat blinds 33, cellular or pleated shades 34, a curtain rail 35, shutters or outer sunblinds 36. To port 14 can also be connected a drive motor on which such a position determination of the sunblind material (for instance the slats) of the sunblind does take place. Examples of such drive motors are motors for raisable and tiltable horizontal slat blinds 37, raisable cellular or pleated shades or so-called sheer shadings 38, and roller blinds 39. The position determination sensor with which the position of the sunblind can be determined is connected to port 15, as shown in FIG. 2.

Microcontroller 10 functions subject to a control programme stored on the microcontroller. Microcontroller 10 is programmed such that, depending on the operating signal coming in to one or more of the ports 11-13, it can determine which protocol is followed by the incoming signal.

If for instance an infrared receiver 16 is connected to microcontroller 10, and infrared remote control 22 sends an infrared signal to infrared receiver 16, receiver 16 receives the infrared signal, converts it into an electrical signal of a determined protocol and transmits this signal 10 as an operating signal to microcontroller. Depending on the information pre-stored on the microcontroller, the microcontroller 10 determines that the received signal complies with the protocol for infrared communication, for instance the IrDA protocol. Once it has been determined which protocol is being followed by the incoming operating signal, the command transmitted by remote control 22 can be interpreted by microcontroller 10 and converted into a control signal for drive motor 6.

When another receiver, such as a radio frequency receiver 17,18, is connected to the same input port 11, microcontroller 10 can determine in the above described manner with which protocol the operating signal generated by remote control 23 or 24 and coming in via an input port complies. In this case the microcontroller determines whether the protocol complies with respectively a basic radio frequency reception protocol or a more comprehensive radio frequency reception protocol. Once the correct protocol has been determined, microcontroller 10 can interpret and convert the incoming operating signal into the correct control signal for the drive motor.

In determined embodiments it is also possible for different receivers to be connected to different input ports 11-13. It is also possible for a wireless receiver 16-18 for instance to be connected to input port 12, while a switch and/or a serial communication line, for instance from a computer, is connected to one or more of ports 11-13. The sunblind can now be operated with two or more different remote controls, with a switch and/or with said computer, since the microcontroller can interpret and convert each incoming operating signal into a correct control signal.

According to a determined preferred embodiment, microcontroller 10 is also adapted to determine the type of drive motor connected to microcontroller 10. In this embodiment the microcontroller is provided with software which enables recognition of a type of motor and adjustment of the control command on the basis of the recognized type of motor.

In another embodiment the microcontroller can be set or even be optimized for the specific motor being used. In the case of factory programming this takes place in the factory. End users or installers can likewise modify the settings of the microcontroller. This functionality forms part of the firmware and can in principle be (subsequently) implemented anywhere, for instance via a specific remote control which makes contact with an already mounted sunblind.

The present invention is described an the basis of an example of a blind with horizontal slats. The invention can however also be universally applied to any other random sunblinds, such as for instance curtains on a curtain rail, optionally raisable roller blinds, pleated and cellular shades, folding blinds and vertical slat blinds. The present invention is not limited to the preferred embodiment thereof described herein. The rights sought are rather defined by the following claims, within the scope of which many modifications can be envisaged.

1-15. (canceled)

16. A control unit for controlling a motor drive of a sunblind, comprising:
(a) an electric drive motor for driving a sunblind;
(b) an electric power supply; and
(c) a universal, programmable microcontroller connected to the power supply, the microcontroller comprising:
(i) at least one input port for receiving first operating signals according to a first signal protocol and for receiving second operating signals according to a second protocol differing from the first protocol, and
(ii) a control port coupled to the drive motor for transmitting to the drive motor a control signal with which the drive motor can be switched on and off; wherein the microcontroller is adapted to receive an incoming operating signal, determine the protocol followed by the operating signal, convert the operating signal into the correct control signal for the drive motor subject to the determined protocol, and transmit the control signal to the drive motor.

17. The control unit of claim 16, wherein the microcontroller comprises at least one first input/output port for receiving and/or transmitting first operating signals according to a first signal protocol, and a second input/output port for receiving and/or transmitting second operating signals according to a second protocol.

18. The control unit of claim 16, wherein the microcontroller comprises a program comprising information about two or more different protocols, on the basis of which the microcontroller determines which of the protocols is being followed by the operating signal.

19. The control unit of claim 18, wherein the microcontroller determines the type of drive motor.

20. The control unit of claim 19, wherein the microcontroller generates the control signal subject to the type of drive motor.

21. The control unit of claim 16, further comprising a receiver connected to a port for receiving signals from a remote control and converting the received signals into the first and second operating signals.

22. The control unit of claim 21, wherein the receiver is an infrared receiver for wirelessly receiving infrared signals and for converting thereof into an electrical operating signal.

23. The control unit of claim 21, wherein the receiver is a radio frequency receiver for wireless reception of radio frequency signals and conversion thereof into an electrical operating signal.

24. The control unit of claim 16, further comprising an electrical on/off-switch connected to a port for providing an operating signal for the microcontroller.

25. The control unit of claim 16, further comprising a communication line connected to a port for providing an operating signal for the microcontroller.

26. The control unit of claim 16, wherein the electric power supply is formed by one or more batteries or by an accumulator.

27. The control unit of claim 16, wherein the control unit is built into an upper rail of a sunblind.

28. The control unit of claim 16, wherein the microcontroller is also adapted to convert an operating signal into a control signal for adjusting the direction of rotation of the drive motor and adjusting the rotation speed of the drive motor.

29. A sunblind comprising:
a frame;
sunblind material on the frame;
the control unit of claim 1, wherein the control unit is provided in the frame, and wherein the drive motor displaces the sunblind material in order to adjust the degree of sun protection.

30. The sunblind of claim 29, wherein the frame comprises an upper frame in which the control unit is positioned and to which a number of slats are attached, wherein the drive motor tilts the slats and for raising or lowering the slats.
